(19) United States
(12) Patent Application Publication
(10) Pub. No.: US 2026/0128527 A1
(43) Pub. Date: May 7, 2026

(54) Helical Antenna As Coupler For Dielectric Waveguide For High Data Rate Communications

(71) Applicant: MediaTek Inc., Hsinchu City (TW)

(72) Inventors: Sang-June Park, San Jose, CA (US); Gurkaranjot Singh Kalra, San Jose, CA (US); Saeed Farsi, San Jose, CA (US); Hsin-Hung Chen, San Jose, CA (US)

(21) Appl. No.: 19/187,945

(22) Filed: Apr. 23, 2025

Related U.S. Application Data
(60) Provisional application No. 63/714,948, filed on Nov. 1, 2024.

(51) Int. Cl. H01Q 11/08

(52) U.S. Cl. CPC H01Q 11/08

(57) ABSTRACT

Techniques pertaining to designs of a helical antenna as a coupler for dielectric waveguides for high data rate communications are described. A coupler to a waveguide cable is configured to allow the waveguide cable to connect to an integrated circuit (IC) chip in a direction normal to the IC chip. The coupler includes a helical antenna which includes a core, a helical structure in the core, and a cladding surrounding the core.

### CROSS REFERENCE TO RELATED PATENT APPLICATION(S)

The present disclosure is part of a non-provisional application claiming the priority benefit of U.S. patent application Ser. No. 63/714,948, filed 1 Nov. 2024, the content of which herein being incorporated by reference in its entirety.

### TECHNICAL FIELD

The present disclosure is generally related to wireline communications and, more particularly, to designs of a helical antenna as a coupler for dielectric waveguides for high data rate communications.

### BACKGROUND

Unless otherwise indicated herein, approaches described in this section are not prior art to the claims listed below and are not admitted as prior art by inclusion in this section.

A waveguide is typically a metal tube or dielectric cable that transmits electromagnetic energy from one place to another. A waveguide with a circular cross section is called a circular waveguide, and a transverse electric (TE) mode TE11 is the dominant mode of operation in a circular waveguide. The mode index “11” represents the field variation along the radial and axial directions, and a signal transmitted in TE11 mode tends to be transmitted with a minimum degradation. A cut-off frequency of a circular waveguide is inversely proportional to a core radius of the circular waveguide. Circular waveguides are relatively easier to manufacture and install than rectangular waveguides.

Radio frequency (RF) circular waveguide are researched to support next-generation artificial intelligence (AI) data centers and autonomous vehicles. The conventional method to launch a signal into circular dielectric waveguide cables typically involves using a Vivaldi antenna with a tapered slot structure. The Vivaldi antenna can provide broadband characteristics, hence it is generally suitable to support a wide bandwidth. However, one drawback of the Vivaldi antenna is that it can only produce radiation in the end-fire direction, thus limiting its scope of applications. Another drawback of the Vivaldi antenna is the complexity in assembling a Vivaldi printed circuit board (PCB) antenna to a waveguide.

Conventional chip-to-chip communication in data centers and automotive applications generally use electrical and optical channels. The electrical channel tends to have a large roll-off in the insertion loss over bandwidth, thus requiring power-hungry equalization. The optical channel, in contrast, has a very small roll-off but is an expensive solution, since it requires an electrical-to-optical conversion. In contrast, the dielectric waveguide (DWG) cables offer performance advantage over electrical links and cost advantage over optical links for a medium range of 1 - 10 meters of distance. Compared to copper, the DWG losses are lower and the bandwidth achievable is higher. Moreover, compared to optical links, DWGs tend to be cheaper and more mechanically robust. One use-case of DWG cables is the connection between a graphics processing unit (GPU) inside a server and a switch integrated circuit (IC) inside an ethernet switch in data centers. This type of applications typically require a coupler that couples a signal normal to the switch IC (e.g., normal or perpendicular to a connection surface of the switch IC) to allow a circular DWG cable to connect to a chip in the normal direction.

However, the conventional solution based on Vivaldi antenna as a coupler for circular DWG can only end-fire the signal and thus is not a feasible solution for data centers and automotive applications. Therefore, there is a need for a solution of designs of a helical antenna as a coupler for dielectric waveguides for high data rate communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to designs of a helical antenna as a coupler for dielectric waveguides for high data rate communications. It is believed that implementations of the various proposed schemes may address or otherwise alleviate the aforementioned issue(s).

In one aspect, a device may include a coupler to a waveguide cable. The coupler may be configured to allow the waveguide cable to connect to an IC chip in a direction normal to the IC chip. The coupler may include a helical antenna.

In another aspect, an apparatus may include a waveguide cable and a coupler to the waveguide cable. The coupler may be configured to allow the waveguide cable to connect to an IC chip in a direction normal to the IC chip. The coupler may include a helical antenna.

It is noteworthy that, although description provided herein may be in the context of certain radio access technologies, networks, and network topologies for wireless communication, such as 5^{th} Generation (5G)/New Radio (NR) mobile communications, 6^{th} Generation (6G) mobile communications and beyond, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example design under a proposed scheme in accordance with an implementation of the present disclosure.

FIG. 2 is a diagram of example design under a proposed scheme in accordance with an implementation of the present disclosure.

FIG. 3 is a diagram of example design under a proposed scheme in accordance with an implementation of the present disclosure.

FIG. 4 is a diagram of example design under a proposed scheme in accordance with an implementation of the present disclosure.

FIG. 5 is a diagram of example design under a proposed scheme in accordance with an implementation of the present disclosure.

FIG. 6 is a diagram of example scenario under a proposed scheme in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to designs of a helical antenna as a coupler for dielectric waveguides for high data rate communications. According to the present disclosure, a number of possible solutions may be implemented separately or jointly. That is, although these possible solutions may be described below separately, two or more of these possible solutions may be implemented in one combination or another.

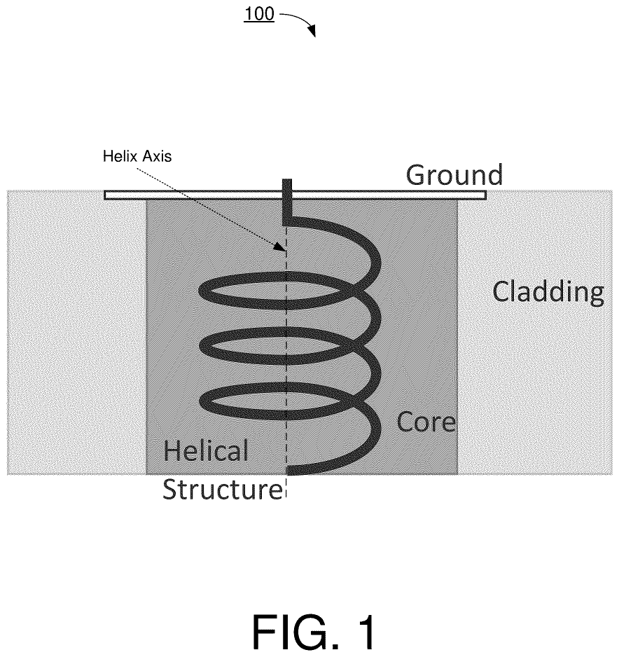

FIG. 1 illustrates an example helical antenna design 100 under a proposed scheme in accordance with the present disclosure. A helical antenna may include a conductor (e.g., an electrically conductive material) wound into a helical shape and, thus, a helical antenna is a three-dimensional radiating structure that produces or otherwise radiates circularly polarized electromagnetic waves, thereby achieving a high gain and large bandwidths. The circular polarization is advantageous, as it is ideally orientation-independent. Critical parameters of a helical antenna are coil diameter, wire diameter, number of turns, and distance between consecutive turns. The radiation field of a helical antenna is normal to its helix axis.

Referring to FIG. 1, the structure or composition of a helical antenna under the proposed scheme may include a helical structure embedded inside a core made of polyethylene material, which may be surrounded circumferentially (e.g., in a radial direction) by a cladding. One end of the helical antenna may be connected to a high-frequency connector or a printed circuit board (PCB), with a metal ground-layer in-between. As the polyethylene material is typically used as the core in circular dielectric waveguides, the same polyethylene material may be used to cover the helical antenna in design 100. Since the polyethylene material is relatively easy to mold, it is suitable for the helical antenna application. The gain of the helical antenna, under a High-Frequency Structure Simulator (HFSS) simulation, may be 4˜7 decibels relative to isotropic (dBi) for an entire 40 GHz bandwidth from 120 GHZ to 160 GHz. Another advantage of the helical antenna is that it is relatively easily pluggable into a dielectric waveguide.

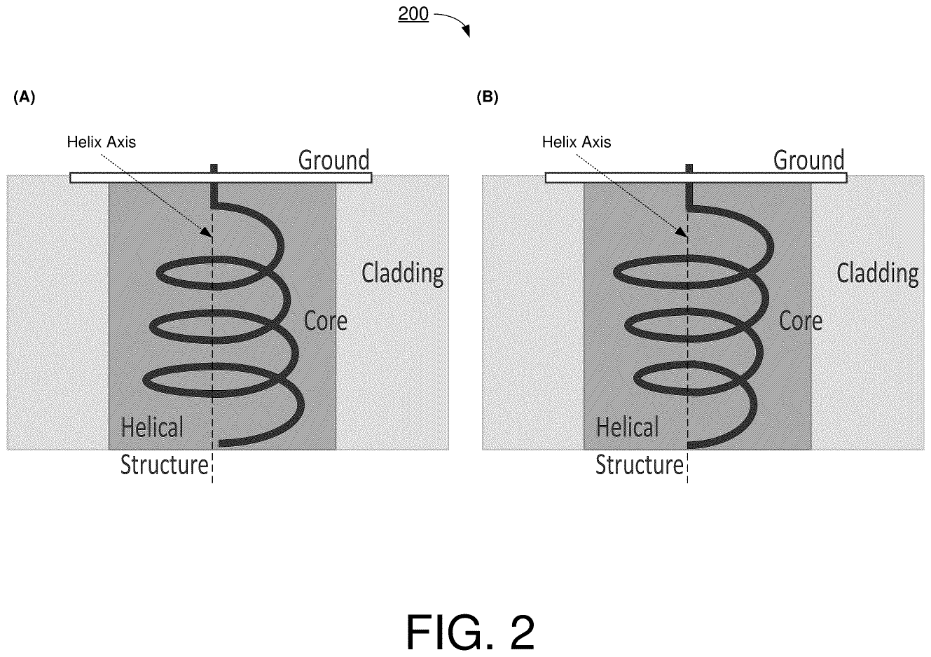

FIG. 2 illustrates an example helical antenna design 200 under a proposed scheme in accordance with the present disclosure. In design 200, the coil of the helical structure may be wound in a tapered manner, thereby improving group delay variation and/or operational bandwidth. Referring to part (A) of FIG. 2, the coil diameter of the helical structure may increase with every helical turn, as viewed from one distal end of the helical structure to an opposite distal end of the helical structure (e.g., away from the electric ground) in a direction parallel to the helix axis of the helical structure. Referring to part (B) of FIG. 2, the coil diameter of the helical structure may decrease with every helical turn, as viewed from one distal end of the helical structure to an opposite distal end of the helical structure (e.g., away from the electric ground) in a direction parallel to the helix axis of the helical structure.

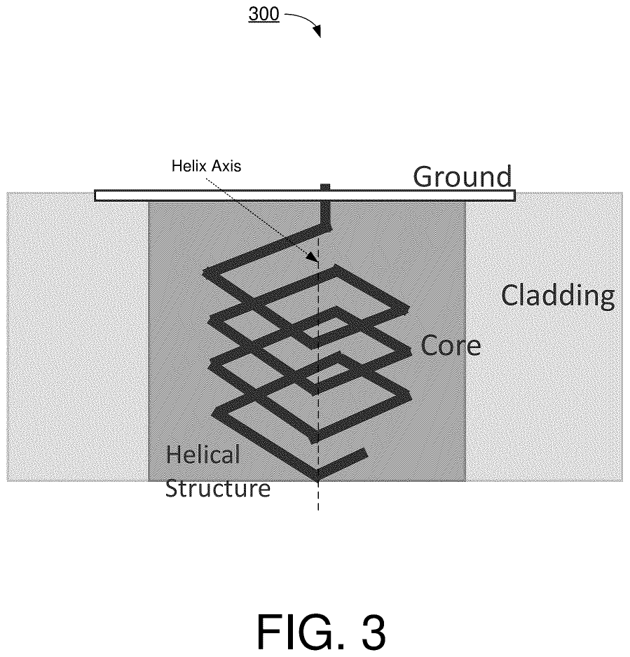

FIG. 3 illustrates an example helical antenna design 300 under a proposed scheme in accordance with the present disclosure. In designs 100 and 200, the helical structure may have circular windings. Different than designs 100 and 200, in design 300, the helical structure may have square-shaped or polygon-shaped windings, as shown in FIG. 3. Moreover, the tapered feature of design 200 may be implemented in design 300 such that the coil diameter may increase or decrease with every helical turn, as viewed from one distal end of the helical structure to an opposite distal end of the helical structure (e.g., away from the electric ground) in a direction parallel to the helix axis of the helical structure.

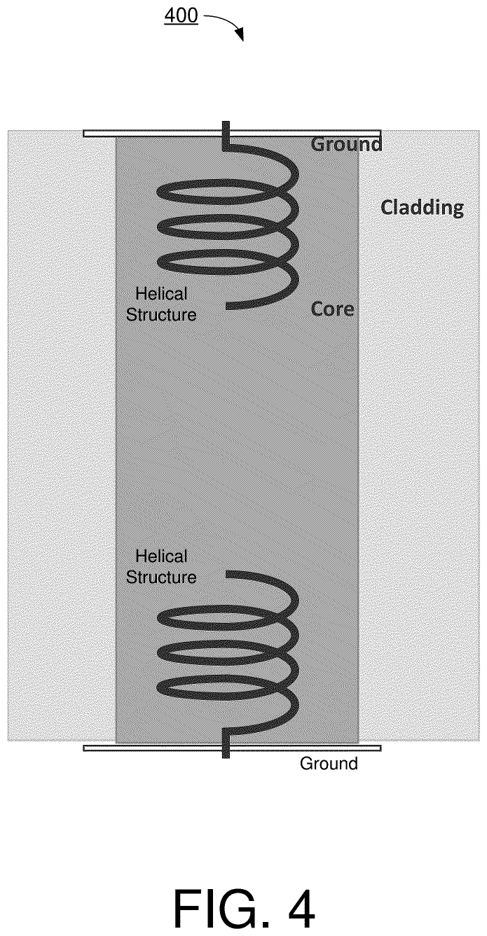

FIG. 4 illustrates an example design 400 under a proposed scheme in accordance with the present disclosure. Design 400 may pertain to a helical antenna for a circular dielectric waveguide. Referring to FIG. 4, design 400 may include a circular dielectric waveguide which may be aligned and epoxied to a helical antenna. The helical antenna may include two helical structures with each disposed at a respective distal end of the circular dielectric waveguide. In some implementations, the core material may be polyethylene while the cladding material may be foam.

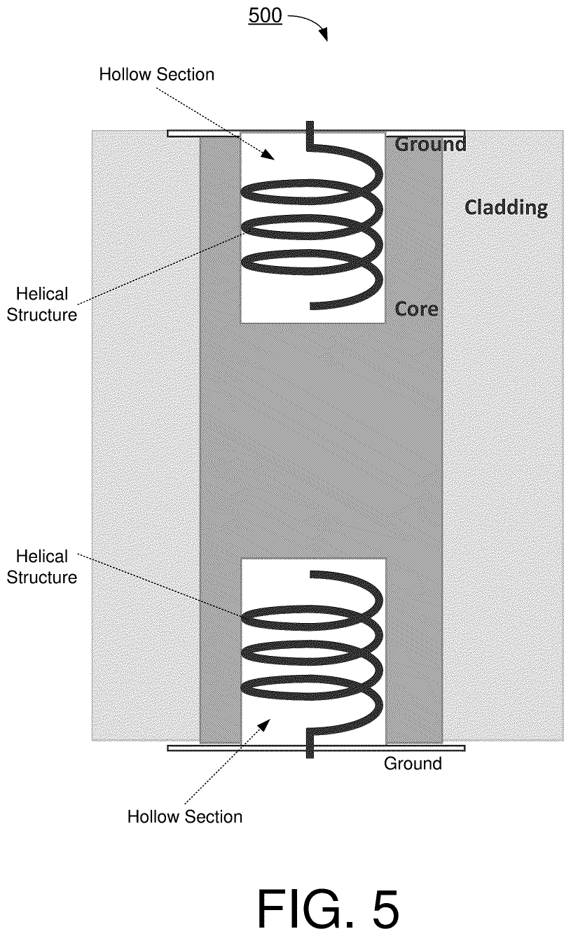

FIG. 5 illustrates an example design 500 under a proposed scheme in accordance with the present disclosure. Design 500 may pertain to an alternative design of a helical antenna for a circular dielectric waveguide. Different from design 400, in design 500, each distal end of the core of the circular dielectric waveguide may have a hollow section carved therein, with a respective helical structure embedded in each hollow section. In some implementations, the core may have a hollow section as a through hole, with two helical antennas each disposed at one respective end of the hollow section in the core.

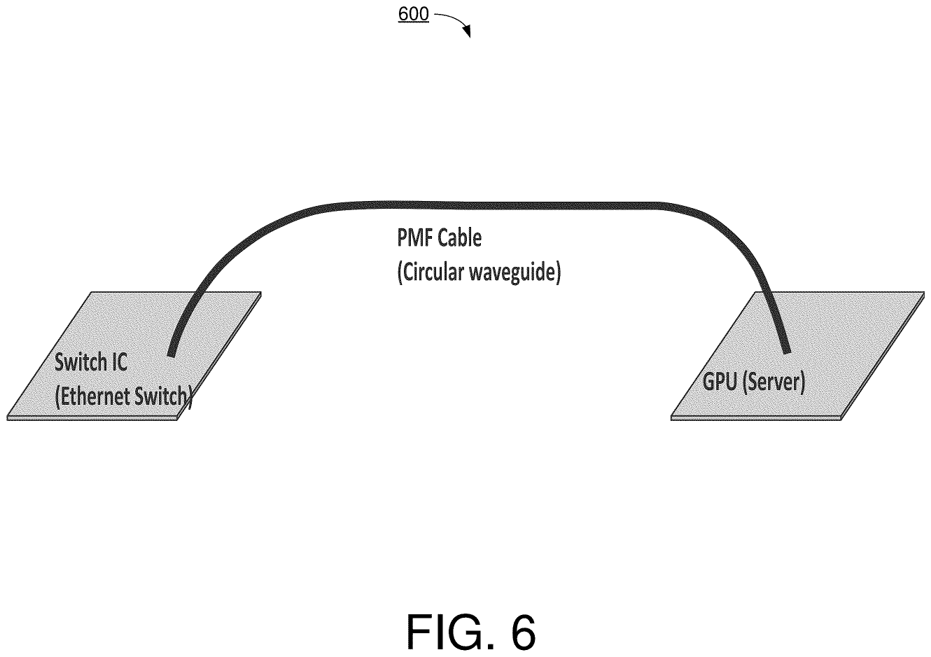

FIG. 6 illustrates an example scenario 600 under a proposed scheme in accordance with the present disclosure. Scenario 600 may pertain to a use-case scenario in which a helical antenna may be utilized as a coupler for a dielectric waveguide (which may in the form of a polarization-maintaining optical fiber (PMF) cable). Referring to FIG. 6, the dielectric waveguide may be used to connect a GPU (e.g., in a server) and a switch IC (e.g., in an ethernet switch) in a data center. The coupler, which may adopt one of the various designs described above with a helical antenna, may couple a signal normal to the switch IC and allow the circular dielectric waveguide cable to connect to the chips in a direction normal to the GPU and switch IC (e.g., normal or perpendicular to a connection surface of each of the GPU and the switch IC), each of which being a type of an IC chip.

In the various designs under the proposed schemes, the helical antenna-based coupler to a dielectric waveguide may achieve very low insertion loss over a wide frequency range while providing a good return loss over a wide bandwidth. Moreover, the proposed coupler may achieve a low group delay variation, thereby avoiding introduction of any inter-symbol-interference.

Accordingly, it is believed that the various proposed designs may overcome limitations of conventional electrical and optical channels. A novel high-frequency channel under each of the various designs may be deployed for high data rate applications such as, for example and not limited to, data centers and automotive applications. The channel may include a circular dielectric waveguide and a helical antenna. The helical antenna may be relatively easily plugged into a dielectric waveguide and, hence, may be suitable for high-speed communication implementations. In the various designs, the three-dimensional helical structure may produce circular polarized electromagnetic waves, which may be aligned to the circular cross-section of the dielectric waveguide. The high gain and large bandwidth provided by the helical antenna may translate to low insertion loss and high data rate at system-level performance, which may be extremely important for applications such as data centers.

### Feature Highlights

In view of the above, select features of the various proposed designs are summarized below.

In one aspect, a device may include a coupler to a waveguide cable. The coupler may be configured to allow the waveguide cable to connect to an IC chip in a direction normal to the IC chip. The coupler may include a helical antenna.

In another aspect, an apparatus may include a waveguide cable and a coupler to the waveguide cable. The coupler may be configured to allow the waveguide cable to connect to an IC chip in a direction normal to the IC chip. The coupler may include a helical antenna.

In some implementations, the helical antenna may include a core, a helical structure in the core, and a cladding surrounding the core.

In some implementations, the helical structure may include a conductor wound into a helical shape as a three-dimensional radiating structure with one end connected to a high-frequency connector or a PCB and configured to produce generally circular polarized waves.

In some implementations, the helical structure may include circular windings. Alternatively, the helical structure may include polygon-shaped (e.g., square-shaped or rectangle-shaped) windings.

In some implementations, a core diameter of the helical structure may increase or decrease with every helical turn as viewed from one distal end of the helical structure to an opposite distal end of the helical structure in a direction away from the electric ground.

In some implementations, the core may include a polyethylene material.

In some implementations, the cladding may include a foam.

In some implementations, the helical structure may be embedded in the core.

In some implementations, a hollow may be carved out of the core, and the helical structure may be received in the hollow.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more; ” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc. ” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc. ” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B. ”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A device, comprising:
a coupler to a waveguide cable, the coupler configured to allow the waveguide cable to connect to an integrated circuit (IC) chip in a direction normal to the IC chip, the coupler comprising a helical antenna.

2. The device of claim 1, wherein the helical antenna comprises:
a core;
a helical structure in the core; and
a cladding surrounding the core.

3. The device of claim 2, wherein the helical structure comprises a conductor wound into a helical shape as a three-dimensional radiating structure with one end connected to a high-frequency connector or a printed circuit board (PCB) and configured to produce generally circular polarized waves.

4. The device of claim 3, wherein the helical structure comprises circular windings.

5. The device of claim 3, wherein the helical structure comprises polygon-shaped windings.

6. The device of claim 3, wherein a core diameter of the helical structure increases with every helical turn as viewed from one distal end of the helical structure to an opposite distal end of the helical structure.

7. The device of claim 3, wherein a core diameter of the helical structure decreases with every helical turn as viewed from one distal end of the helical structure to an opposite distal end of the helical structure.

8. The device of claim 2, wherein the core comprises a polyethylene material.

9. The device of claim 2, wherein the cladding comprises a foam.

10. The device of claim 2, wherein the helical structure is embedded in the core.

11. The device of claim 2, wherein a hollow is carved out of the core, and wherein the helical structure is received in the hollow.

12. An apparatus, comprising:
a waveguide cable; and
a coupler to the waveguide cable, the coupler configured to allow the waveguide cable to connect to an integrated circuit (IC) chip in a direction normal to the IC chip, the coupler comprising a helical antenna.

13. The apparatus of claim 12, wherein the helical antenna comprises:
a core;
a helical structure in the core; and
a cladding surrounding the core.

14. The apparatus of claim 13, wherein the helical structure comprises a conductor wound into a helical shape as a three-dimensional radiating structure with one end connected to a high-frequency connector or a printed circuit board (PCB) and configured to produce generally circular polarized waves.

15. The apparatus of claim 14, wherein the helical structure comprises circular windings or polygon-shaped windings.

16. The apparatus of claim 14, wherein a core diameter of the helical structure increases or decreases with every helical turn as viewed from one distal end of the helical structure to an opposite distal end of the helical structure.

17. The apparatus of claim 13, wherein the core comprises a polyethylene material.

18. The apparatus of claim 13, wherein the cladding comprises a foam.

19. The apparatus of claim 13, wherein the helical structure is embedded in the core.

20. The apparatus of claim 13, wherein a hollow is carved out of the core, and wherein the helical structure is received in the hollow.
